(19) United States
(12) Patent Application Publication
(10) Pub. No.: US 2009/0053493 A1
(43) Pub. Date: Feb. 26, 2009

(54) PRINT-THROUGH CONTROL

(75) Inventors: Howard S. Creel, Oakdale, MN (US); Robert M. Jennings, Shoreview, MN (US); Duane A. Lunsford, Stacy, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/194,746

(22) Filed: Aug. 20, 2008

Related U.S. Application Data
(60) Provisional application No. 60/956,909, filed on Aug. 20, 2007.

(51) Int. Cl. B32B 3/26; B32B 37/14

(52) U.S. Cl. 428/218; 428/304.4; 156/306.9; 156/307.1; 156/307.3

(57) ABSTRACT

Composite articles having a cosmetic layer, a structural layer comprising a fiber reinforced resin, and a compressible layer positioned between the cosmetic layer and the structural layer are described. The cosmetic layer has a Young's modulus of at least 1.0 GPa and the compressible layer has a Young's modulus of less than or equal to 50 MPa. Print-through control layers having a compressible layer and at least one skin coat are also described, as are methods of forming composite articles and methods of controlling print through.

### CROSS-REFERENCE TO RELATED APPLICATION

This application claims the benefit of U.S. Provisional Patent Application No. 60/956,909, filed Aug. 20, 2007, the disclosure of which is incorporated by reference herein in its entirety.

### FIELD

The present disclosure relates to the control of print-through during the fabrication of composite materials having a cosmetic layer. More specifically, the present disclosure relates to a print-through control layer having a compressible layer.

### SUMMARY

Briefly, in one aspect, the present disclosure provides composite article comprising a cosmetic layer having a Young's modulus of at least 1.0 GPa; a structural layer comprising a fiber reinforced resin; and a compressible layer positioned between said cosmetic layer and said structural layer, wherein said compressible layer has a Young's modulus of less than or equal to 50 MPa. In some embodiments, the cosmetic layer comprises a surface layer and at least one skin coat. In some embodiments, the composite article further comprises a fiber reinforced layer between the compressible layer and the structural layer.

In some embodiments, the compressible layer is a solid polymer selected from the group consisting of acrylic polymer, epoxy, and mixtures thereof. In some embodiments, the compressible layer comprises a foam. In some embodiments, the compressible layer comprises holes.

In another aspect, the present disclosure provides a method of controlling print-through comprising: positioning a compressible layer having a Young's modulus of less than or equal to 50 MPa between a cosmetic layer having a Young's modulus of at least 1 GPa; and a structural layer comprising a fiber reinforced resin; and curing the resin to form a composite article. In some embodiments, the method further comprises positioning a fiber reinforced layer between the compressible layer and the structural layer.

In yet another aspect, the present disclosure provides a method of forming a composite article comprising positioning a compressible layer having a Young's modulus of less than or equal to 50 MPa between a cosmetic layer having a Young's modulus of at least 1 GPa; and a structural layer comprising fiber reinforcements and a structural resin; and curing the resin to form a composite article. In some embodiments, the method further comprises infusing the fibrous reinforcements with the structural resin, optionally wherein infusing comprises vacuum infusing.

In another aspect, the present disclosure provides a print-through control layer comprising a compressible layer and at least one skin coat. In some embodiments, the compressible layer has a Young's modulus of no greater than 10 MPa and a Poisson's ratio no greater than 0.49. In some embodiments, the compressible layer is a solid polymer selected from the group consisting of acrylic polymer, epoxy, and mixtures thereof.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF DRAWINGS

FIG. 1 shows the surface structure spectrum for Example 1.

FIG. 2 shows the surface structure spectrum for Example 2.

FIG. 3 shows the surface structure spectrum for Example 3.

FIG. 4 shows the surface structure spectrum for Example 4.

FIG. 5 shows the surface structure spectrum for Example 5.

FIG. 6 shows the surface structure spectrum for Example 6.

FIG. 7 shows the surface structure spectrum for Example 7.

FIG. 8 shows the surface structure spectrum for Example 8.

FIG. 9 shows the surface structure spectrum for Example 9.

FIG. 10A illustrates an exemplary composite article according to some embodiments of the present disclosure.

FIG. 10B illustrates an exemplary composite article according to some embodiments of the present disclosure, which includes one or more additional layers.

FIG. 10C illustrates an exemplary composite article according to some embodiments of the present disclosure, which includes multiple skin coats.

FIG. 10D illustrates an exemplary composite article according to some embodiments of the present disclosure, which includes an additional fiber-reinforced layer.

FIG. 10E illustrates an exemplary composite article according to some embodiments of the present disclosure, which includes holes extending through the thickness of the compressible layer.

### DETAILED DESCRIPTION

The term “gel coat” is defined herein as a highly cross linked thermoset coating.

The term “skin coat” is defined herein as a hand-laid, fiber reinforced, resin rich layer.

The term “structural layer” is defined herein as a structural reinforcing layer comprising a fiber reinforced resin.

The term “structural portion” refers to the portion of a composite article comprising one or more structural layers.

The term “compressible layer” is defined herein as any solid and/or foamed compressible material having a having relatively low moduli when compared to moduli of the cosmetic layer.

Generally, a composite article comprises one or more layers of a cured, reinforced resin, for example, one or more structural layers. Generally, the resin of a structural layer is reinforced with fibers. The fibers may be random or structured. Exemplary structured fibers include fabrics, woven and nonwoven webs, knits, scrims, and the like.

Often, a cosmetic layer is included on at least one surface of the structural portion of the composite article. Generally, the cosmetic layer provides desired aesthetic properties such as color, smoothness, and high gloss. The cosmetic layer may also provide functional properties including, e.g., hardness, crack resistance, and moisture resistance.

Potentially, all composite parts with a cosmetic surface may be subject to deleterious print-through, which refers to visible surface deformations resulting from the presence or curing of the underlying structural layers. For example, print-through may be caused by the stress developed from differential shrinkage of matrix resins compared to the fiber reinforcements of the structural layers during cure of the resin. Generally, these stresses result in surface deformations corresponding to the pattern of the fiber reinforcements, resulting in print-through.

In the composites industry, the visible surface of a composite part is created using a gel coat. Any known gel coat may be used. Exemplary gel coat compositions include filled unsaturated polyester resin using styrene as a reactive diluent. Epoxy resins have also been used.

The gel coat may be sprayed on the surface of a mold with a glossy surface, and the composite part is fabricated as successive structural layers are laid up behind the cosmetic layer: in effect, the part is built from the outside in. After curing the gel coat and the resin of the structural layers, the part is de-molded and the gel coat layer forms the outer cosmetic layer.

One approach to controlling print-through includes increasing the stiffness of the cosmetic layer (e.g., by increasing the stiffness of a gel coat layer). One way to accomplish this is to include a skin coat as part of the cosmetic layer. Generally, a skin coat is created by hand-laying a fiber reinforced, resin rich layer against the gel coat and curing the resin prior to applying additional layers, e.g., structural layers. Other materials can be used in combination with the hand-laid, fiber reinforced, resin rich layer, including but not limited to barrier coats and syntactic coatings.

Generally, the presence of the skin coat increases the thickness, and thus the stiffness, of the cosmetic layer, which can lessen the severity of stress-induced deformation and the resulting print-through on the visible surface of the composite article. In addition to providing some degree of print-through control, the skin coat may also reinforce the relatively brittle surface (e.g., gel coat) layer and provide a water barrier.

Commercially available products intended for print-through control, e.g., barrier coats and syntactic coatings, are typically very high modulus materials. These products attempt to control print-through by increasing both the thickness and the stiffness of the cosmetic layer.

In contrast to these “increased thickness and increased stiffness” approaches to print-through control, the present inventors have discovered that print-through can be controlled through the use of a low modulus, compressible layer placed between the cosmetic layer and the structural portion of the composite article. In some embodiments, such compressible layers may be used alone, or in conjunction with, e.g., skin coats, to not only control print-through, but also to reinforce the gel coat layer and/or provide a water barrier.

As mentioned, print-through has been reduced by increasing the modulus and/or the thickness of the cosmetic layer, as is generally accepted. However, the fact that print-through can also be reduced by including a low modulus print-through control layer is unexpected.

Generally, the compressible layer can be any layer having a modulus (i.e., a Young's modulus) significantly less than the modulus of the cosmetic layer. Typical cosmetic layers have a Young's modulus of at least 1 GPa, in some embodiments, at least 2 GPa, or even at least 5 GPa. Exemplary compressible layers may have a Young's modulus of no greater than 25 MPa, in some embodiments, no greater than 10 MPa, no greater than 5 MPa, no greater than 2 MPa, or even no greater than 1 MPa. In some embodiments, the compressible layer may have a Young's modulus of less than 1 MPa, for example, no greater than 0.5 MPa, or even no greater than 0.25 MPa.

In some embodiments, the compressible layer comprises a compressible adhesive layer. In some embodiments, the compressible layer comprises a compressible foam layer, either alone or in combination with at least one adhesive layer. For example, in some embodiments, the compressible layer comprises a foam layer having an adhesive layer on both major surfaces. Exemplary adhesives include acrylic adhesives, and rubber-based (natural, and synthetic rubber) adhesives.

Generally, compressible layers having a lower Poisson's ratio are more effective at controlling print-through. In some embodiments, the Poisson's ratio is less than 0.49, in some embodiments, no greater than 0.45, no greater than 0.4, or even no greater than 0.3.

Generally, the level of print-through control obtained by using a low modulus material depends on the modulus and Poisson's ratio of the material and the thickness of the compressible layer. Generally, the lower the modulus and Poisson's ratio and the thicker the compressible layer, the greater the degree of print-through control. Also, the use of lower Poisson's ratio materials may allow the use of higher modulus materials and/or thinner compressible layer to obtain the same degree of print-through control.

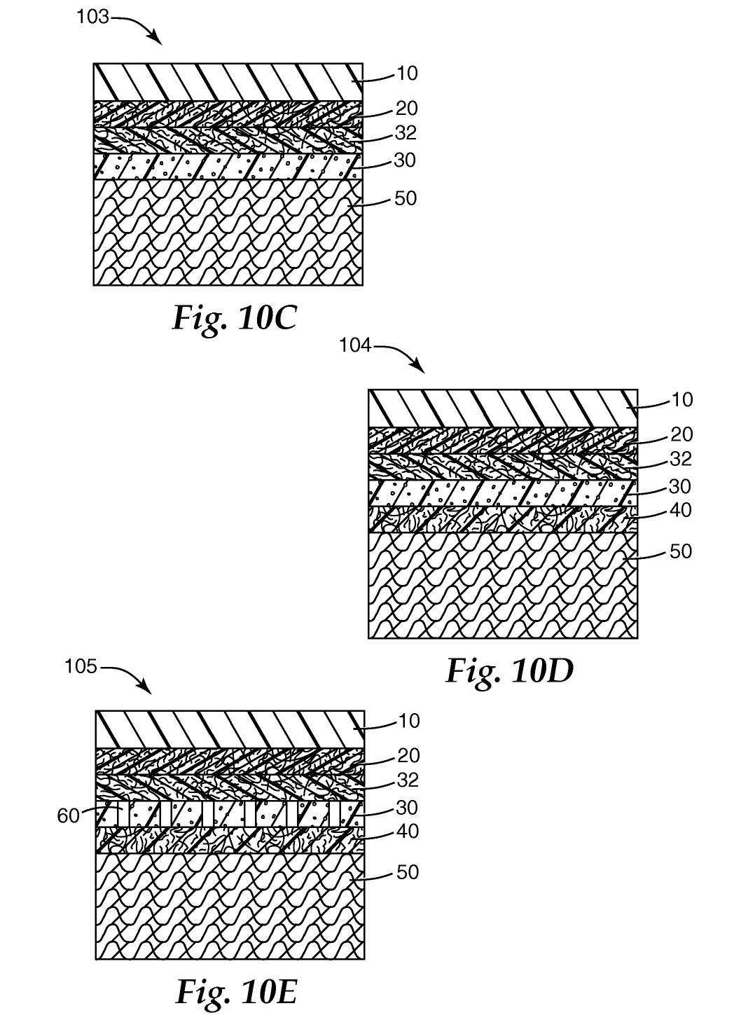

Referring to FIG. 10A, composite article 101 according to some embodiments of the present disclosure is shown. Composite article 101 comprises surface layer 10, which may comprise a gel coat, and structural portion 50, which comprises one or more structural layers. Surface layer 10 corresponds to the cosmetic layer of composite article 101. Composite article 101 also includes compressible layer 30 interposed between structural portion 50 and surface layer 10. As shown in FIG. 10A, compressible layer 30 is bonded to both the surface layer and the structural portion.

In some embodiments, one or more additional layers may be included in the composite articles of the present disclosure. For example, referring to FIG. 10B, composite article 102 includes skin coat 20 positioned between and bonded to surface layer 10 and compressible layer 30. For composite article 102, the cosmetic layer comprises both surface layer 10 and skin coat 20. Composite article 102 also includes structural portion 50, which comprises one or more structural layers.

In some embodiments, composite articles of the present disclosure may include a skin coat applied directly to the cosmetic layer. In some embodiments, a skin coat may be included with the compressible layer. In some embodiments, such a skin coat may be applied directly to the surface layer. However, in some embodiments, a first skin coat is applied directly to the surface layer, and a second skin coat is included with, e.g., integral to, the compressible layer. For example, referring to FIG. 10C, composite article 103 includes surface layer 10 and structural portion 50, comprising one or more structural layers. First skin coat 20 is bonded to surface layer 10. Second skin coat 32 and compressible layer 30 are then positioned between and bonded to first skin coat 20 and structural portion 50. For composite article 103, the cosmetic layer comprises surface layer 10 and both first skin coat 20 and second skin coat 32.

In some embodiments, an additional fiber-reinforced layer may be located between the compressible layer and the structural portion, either alone or included with one or more skin coats positioned between the compressible layer and the surface layer. In some embodiments, such a layer may be included with, e.g., integral with, the compressible layer. For example, referring to FIG. 10D, composite article 104 comprises surface layer 10, compressible layer 30, and structural portion 50, which comprises one or more structural layers. First skin coat 20 and second skin coat 32 are positioned between the surface layer and the compressible layer. Additional fiber-reinforced layer 40 is positioned between and bonded to compressible layer 30 and structural portion 50.

Referring to FIG. 10E, composite article 105 includes surface layer 10, structural portion 50, comprising one or more structural layers, and compressible layer 30. Compressible layer 30 includes holes 60 extending through the thickness of the compressible layer. In some embodiments, the holes may be formed by perforating the compressible layer. Such holes may be useful for facilitating the removal of air bubbles formed during the various lamination processes. FIG. 10E also includes optional first skin coat 20, second skin coat 32, and additional fiber-reinforced layer 40.

### EXAMPLES

The following specific, but not-limiting, examples will serve to illustrate the invention.

### Test Methods

Apply Gel coat to Mold. A glass panel (61 cm×91 cm×0.95 cm) was treated with Flex-Z 3.0 SLIPCOAT SYSTEM (Zyvax Inc., Boca Raton, Fla. USA) per supplier instructions.

The cure of 75 g of Ashland WG-MP-4000 gel coat (Express Composites, Minneapolis Minn. USA) was initiated using 1.5 g of 2-butanone peroxide solution (Luperox® DDM-9˜35% in 2,2,4-trimethyl-1,3-pentanediol diisobutyrate, Aldrich Chemical, Milwaukee Wis. USA), mixed by hand with a tongue depressor and further mixed using a DAC 150 FV SpeedMixer™ (FlackTek Landrum, S.C., USA).

The resulting gel coat mixture was spread on the glass plate using a 0.5 mm (20 mil) wet film draw down bar (Gardco, Inc., Pompano Beach, Fla. USA) to provide a cured gel coat layer of a nominal thickness of 0.5 mm. The gel coat was allowed to cure for an hour. The applied gel coat layer was trimmed to nominal dimensions of 15 cm×41 cm.

Apply the Skin Coat. In a typical procedure, the mass of a 15 cm×41 cm piece of fiberglass chopped strand mat (CSM) was measured and an amount of Ashland VE 922L-25 vinyl ester resin (Express Composites) equivalent to twice the mass of the chopped strand mat was initiated using an amount of 2-butanone peroxide solution (Luperox® DDM-9˜35% in 2,2,4-trimethyl-1,3-pentanediol diisobutyrate, Aldrich Chemical) equivalent to 1.5% of the mass of the vinyl ester resin. These ratios were used for chopped strand mats of various densities measured as ounces per square foot (oz/ft2) and converted to grams per square meter (g/m2).

For instance the mass of a 15 cm×41 cm piece of 916 g/m2 (3 oz/ft2) CSM (Fiberglass Warehouse, La Mesa Calif. USA) was measured at 57 g. A mass of 114 g of Ashland VE 922L-25 vinyl ester resin (Express Composites, Minneapolis Minn. USA) was measured into a plastic beaker and was mixed with 1.7 g of 2-butanone peroxide solution by hand using a wooden tongue depressor. Uniform mixing of the initiator was assured by a change in resin color from red to brown.

A small portion of the initiated resin was applied in an even layer on the cured gel coat using a paint applicator. The chopped strand mat layer was laid on the wet resin layer and the remainder of the mixed, initiated resin poured on and impregnated uniformly in the chopped strand mat using a knurled, aluminum roller (Fiberglass Warehouse), in such a way to minimize the number of air bubbles remaining in the wet resin. The resin impregnated chopped strand mat layer was allowed to cure for approximately four hours.

Using such a procedure, several layers of chopped strand mat could be laminated together to provide skin coats of various thicknesses. Details of the types of chopped strand mats and the resulting skin coats are listed in Table 1 below. All chopped strand mat was obtained from Fiberglass Warehouse.

TABLE 1
Chopped strand mat parameters.

| CSM | Mass 15 cm × 41 cm | | Skin coat |
|---|---|---|---|
| Density | CSM | Mass of Resin | Thickness |
| g/m² (oz/ft²) | (g) | (g) | (mm) |
| 229 (0.75) | 14 | 28 | 0.89 |
| 305 (1.0) | 19 | 38 | 1.18 |
| 458 (1.5) | 28 | 56 | 1.78 |
| 916 (3.0) | 57 | 114 | 2.67 |

Apply Print-through Control Layer. The print-through control materials used herein feature tacky surfaces on both side that enabled (in some cases) lamination directly to the gel coat or cured skin coat. In a typical procedure, the materials were obtained in roll form with a silicone treated paper release liner laminated to one side. The side of the print-through control material without the release liner was applied to the cured gel coat or skin coat layer surface and rolled out by hand using a standard J-roller. The process of installing a print-through layer using this method is called direct lamination.

In other cases, a 15 cm×41 cm piece of 229 g/m2 (0.75 oz/ft2) chopped strand mat was hand laminated to one side of the print-through control material. To attach the print-through control material to the gel coat or other skin coat layer, the chopped strand mat on the print-through control layer was impregnated with 28 g of initiated, mixed vinyl ester resin as described previously. The resin impregnated chopped strand mat was applied to the gel coat or previously applied skin coat layer and rolled out to minimize air bubbles. The resin was allowed to cure, typically for four hours, to complete the application of the print-through layer. The process of installing a print-through layer using this method is called one-sided CSM lamination.

In some cases, an additional 15 cm×41 cm pieces of 229 g/m2 (0.75 oz/ft2) chopped strand mat was hand laminated to the remaining side of the print-through control material. To complete the installation of this print-through control layer, 28 g of initiated, mixed vinyl ester resin was used to impregnate the chopped strand mat and rolled out as described previously to minimize air bubbles. The resin was allowed to cure typically for four hours to complete the application of the print-through layer. The process of installing a print-through layer using this method is called two-sided CSM lamination.

Apply Structural Reinforcement. Four 15 cm×41 cm pieces of CDM1808 fiberglass (50/50 0°/90° knitted E-glass biaxial fabric with an attached layer of 244 g/m2 (0.8 oz/ft2) chopped fibers) (Fiberglass Warehouse) were placed on the previously applied cosmetic layer comprised of gel coat, various thicknesses of skin coat and the print-through control layer. The weft (90°) plies of the first CDM1808 cut piece were placed down on the applied cosmetic layer aligned with the long axis of the applied cosmetic layer. The remaining three plies were placed on the first to result in a 2[0,90,R]S lay-up.

Prepare Vacuum Infusion Set-up. Standard techniques of vacuum infusion were used to infuse the structural fabrics with Ashland VE 922L-25 vinyl ester resin (Express Composites). Details of the process are available from sources such as Airtech Basic Infusion Video, (Airtech International, Inc.) and Vacuum Infusion Video (GRPGuru, Brunswick, Me. USA). The process is outlined in general below.

A 15 cm×51 cm piece of peel ply (Econolease, Airtech International Inc.) was placed on top of the structural fabrics, followed by a 15×36 cm piece of flow media (Greenflow 75, Airtech International Inc.) placed on the peel ply. The peel ply (to facilitate removal of disposable materials from the infused panel) and the flow media (to aid resin flow) were both placed flush with the one of the 15 cm ends of the structural fabric stack, which becomes the resin inlet end.

A resin inlet was fashioned from a length of 6.35 mm inner diameter hose suitable for vacuum operations by placing a plastic tee (Polyethylene Tees 10/pack ¼″ MSC Industrial Supply Company, Melville N.Y. USA) in one end and winding a 10 cm piece of spiral wrap tubing (Polyethylene Tube Harnessing ⅜″ OD, MSC Industrial Supply Company) over the end of the plastic tee. A similar construction is fabricated for use as a vacuum outlet. The resin inlet was placed on top of the flow media on the one end of the test panel material stack. The vacuum outlet was placed approximately 5 cm from the other end of the test panel material stack, sitting on the peel ply.

A sealant material (AT-200Y, Airtech International Inc.) was placed around the perimeter of the test panel material stack in such a way to provide a vacuum seal. A vacuum bag film (Dahlar® Release Bag 125, Airtech International Inc.) was placed over the test panel material stack and secured to the sealant. The resin inlet was clamped closed, the vacuum outlet hose connected to a vacuum pump and the space formed between the glass mold surface and the vacuum bag evacuated to a stable vacuum of approximately 711 mm Hg.

A 450 g portion of Ashland VE 922L-25 vinyl ester resin (Express Composites) was mixed in a 1000 mL plastic beaker with 6.75 g of 2-butanone peroxide solution (Luperox® DDM-9˜35% in 2,2,4-trimethyl-1,3-pentanediol diisobutyrate, Aldrich Chemical) and mixed as previously described. The end of the resin inlet hose was placed in initiated resin and the clamp released. The resin was allowed to completely infuse the structural fiberglass layers, typically within 13 minutes of clamp release. The resin was allowed to cure at room temperature for 4 hours, at which time the disposable layers (peel ply, flow media, bagging film, resin inlet, vacuum outlet, and sealant) were removed from the infused panel and the panel removed from the glass surface. Typically, the print-through state of the panels was analyzed after a week at room temperature.

Measurement of the Structure Spectrum. The amount of print-through on the surface of the panels was measured using a Micro-Wave-Scan (Paul N. Gardner Company, Inc., Pompano Beach, Fla. USA). The Micro-Wave-Scan measures the optical profile for surface structure sizes up to 10 mm. By applying mathematical filter functions to the optical profile, the structure spectrum is obtained. These measured values, Wa through Wd, represent structure sizes within a specific surface structure wavelength range.

The measurement range for the structure spectrum goes from 0 (smooth) to 100 (highly structured) with the values having no dimension. Dullness (du) is a measurement of light scattering caused by structures smaller than 0.1 mm. The wavelength ranges of the measured values are listed in Table 2 below. The print-through pattern resulting from the CDM1808 structural fabric was found in the 3-10 mm range, thus the value of Wd was the most indicative of the print-through state of a panel.

TABLE 2
Wavelengths corresponding to measure ranges.

| Measured Values | Wavelength of Measured |
|---|---|
| Structure Spectrum | Structure (mm) |
| du | <0.1 |
| Wₐ | 0.1-0.3 |
| W_{b} | 0.3-1 |
| W_{c} | 1-3 |
| W_{d} | 3-10 |

Typically a 20 cm scan was taken at three different points on the panel with an average of three scans at each point, for a total of nine scans per panel.

A variety of 3M™ VHB™ adhesive transfer tapes were used to prepare the following examples, as summarized in Table A below. The reported Young's Modulus was estimated as 3 times the shear modulus at 25° C. and 1 Hz as reported in “3M™ VHB™ Tapes. Technical Data,” dated November, 2005.

TABLE A
Properties of 3M ™ VHB ™ adhesive transfer tapes.

| | | | | Foam | Young's |
|---|---|---|---|---|---|
| | | Caliper | | density | Modulus |
| Product | Description | mm | inch | kg/m³ | MPa |
| 4926 | conformable acrylic foam | 0.38 | 0.015 | 720 | 0.9 |
| | core tape | | | | |
| 4936 | conformable acrylic foam | 0.64 | 0.025 | 720 | 0.9 |
| | core tape | | | | |
| 4941 | conformable acrylic foam | 1.14 | 0.045 | 720 | 0.9 |
| | core tape | | | | |
| 4956 | conformable acrylic foam | 1.57 | 0.062 | 720 | 0.9 |
| | core tape | | | | |
| 4920 | firm acrylic foam core tape | 0.38 | 0.015 | 800 | 1.8 |
| 4930 | firm acrylic foam core tape | 0.64 | 0.025 | 800 | 1.8 |
| 4950 | firm acrylic foam core tape | 1.14 | 0.045 | 800 | 1.8 |
| 4955 | firm acrylic foam core tape | 2.03 | 0.080 | 800 | 1.8 |
| 9460 | Clear adhesive transfer tape | 0.05 | 0.002 | N/A | N/A |
| 9473 | Thicker version of 9460 | 0.25 | 0.010 | N/A | N/A |

Poisson's ratio is defined as the negative of the ratio of the transverse strain to the longitudinal strain. The technique involved taking. An estimate of the Poisson's ratio for the eight foam products was based on measurements made using 3M™ VHB™ adhesive transfer tapes No. 4956. An estimate of the Poisson's ratio for the 3M No. 9460 was based on measurements obtained from a six layer stack of 3M No. 9473 adhesive transfer tape. In both cases, a sample thickness of approximately 1.5 mm (0.060 inch) was obtained.

The tape samples were adhered between two platens by the skin adhesive of the tape. Deformation was controlled with a micrometer attached to one platen. The other platen remained fixed. The sample aspect ratio was >/=2 and was controlled by hand cutting tape samples with a razor blade under magnifying glasses. Compressive, relaxed, and tensile deformations were made in the direction perpendicular to the sheet of tape (thickness direction). Digital pictures of both at-rest and slightly deformed tape samples were collected. These pictures were then analyzed by software called “Vic2D” from Correlated Solutions. The software correlates changes in the sequential images and calculates longitudinal and transverse displacements from which strain data can be calculated. The tape was equilibrated at conditions of 23° C. (73° F.), 50% RH. The measurements were also carried in this environment.

The estimated Poisson's ratio for the foam tapes was measured as 0.30 with a standard deviation of 0.06. The Poisson's ratio for the clear adhesive transfer tape was measured as 0.45 with a standard deviation of 0.05.

### Example 1

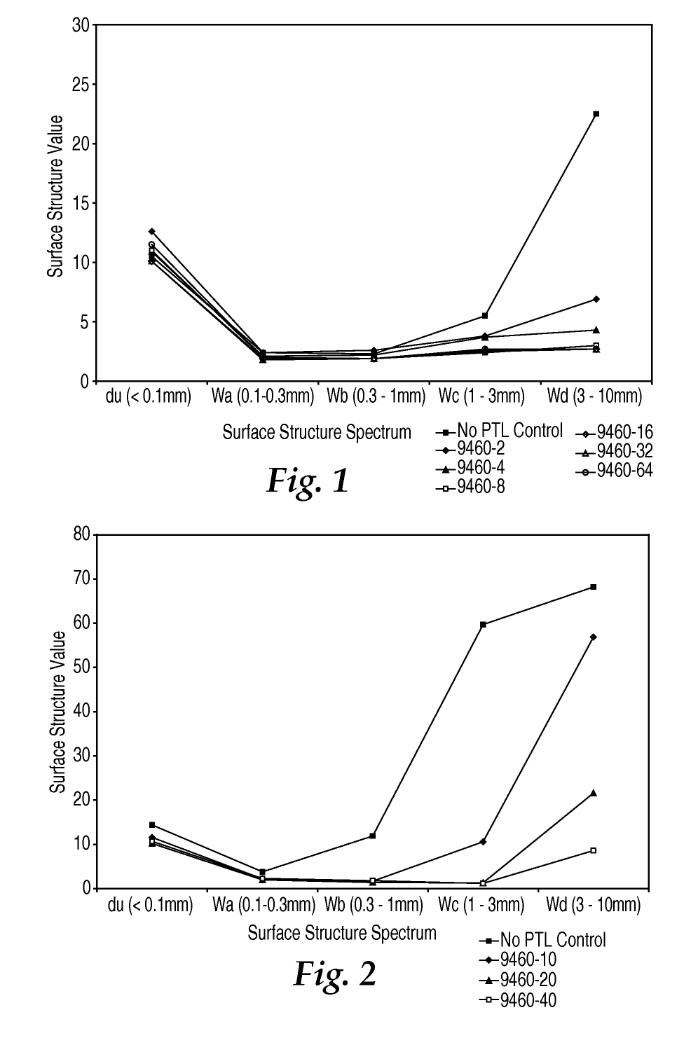

Increasing 9460 Thickness with Constant Skin Coat. Referring to FIG. 1, 3M™ VHB™ Adhesive Transfer Tape 9460 was hand-laminated to various thicknesses for use as a print-through control layer. Each print-through control material was directly laminated to the cosmetic layer using direct lamination (described above). The structural layers were infused as described above, and the surface structure spectrum of the panels was analyzed one week after the infusion as described above. The results are summarized in Table 3 and FIG. 1.

TABLE 3
Effect of thickness on print-through for Example 1 (Wd).

| Cosmetic Layer | | | Print-through Control Layer | | |
|---|---|---|---|---|---|
| Thickness (mm) | | | 3M ™ VHB ™ Adhesive | | |
| | Skin | | Transfer Tape 9460 | Thickness | |
| Gel coat | coat | Total | Designation | (mm) | W_{d} |
| 0.5 | 1.8 | 2.3 | No PTL Control | 0 | 22.5 |
| 0.5 | 1.8 | 2.3 | 9460-2 | 0.05 | 6.9 |
| 0.5 | 1.8 | 2.3 | 9460-4 | 0.1 | 4.3 |
| 0.5 | 1.8 | 2.3 | 9460-8 | 0.2 | 3.0 |
| 0.5 | 1.8 | 2.3 | 9460-16 | 0.4 | 2.7 |
| 0.5 | 1.8 | 2.3 | 9460-32 | 0.8 | 2.7 |
| 0.5 | 1.8 | 2.3 | 9460-64 | 1.6 | 2.7 |

### Example 2

Increasing 9460 Thickness with No Skin Coat. Referring now to FIG. 2, 3M™ VHB™ Adhesive Transfer Tape 9460 was hand-laminated to the thicknesses listed below for use as print-through control layer. Each print-through control material was directly laminated to the gel coat with no applied skin coat using direct lamination (described above). The structural layers were infused using the technique described above. The surface structure spectrum of the panels was analyzed one week after the infusion. The results are reported in Table 4 and FIG. 2.

### Example 3

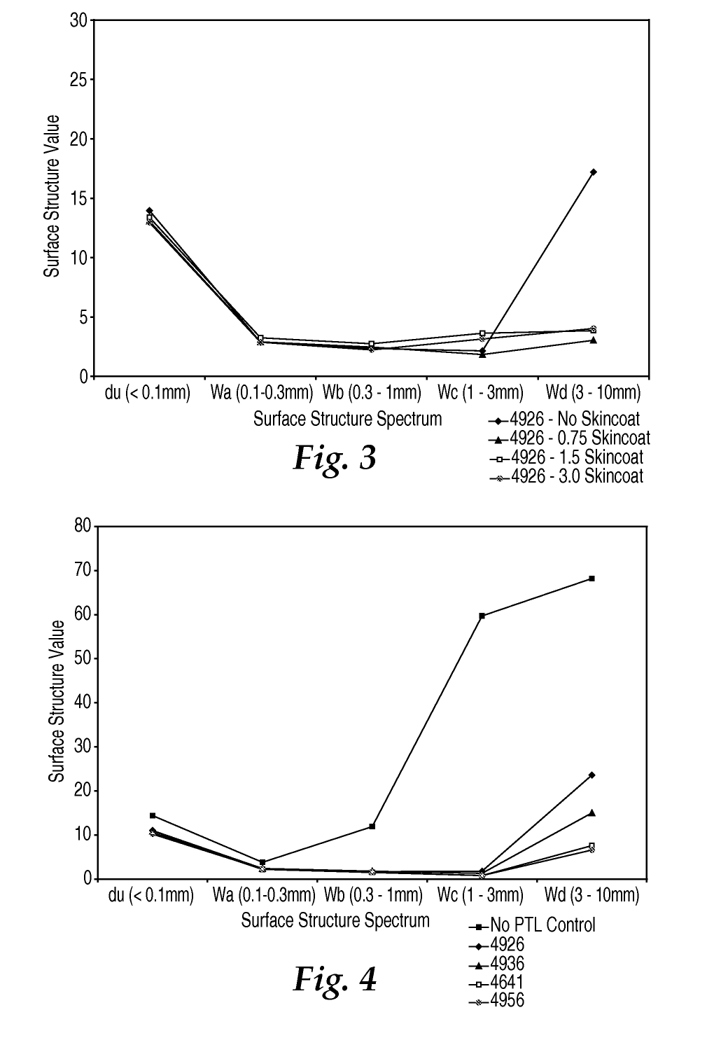

Increasing 4941 VHB Series Thickness with No Skin Coat. Referring now to FIG. 3, various 3M™ VHB™ Tapes in the 4941 family of tapes, as listed below were directly laminated to the gel coat with no applied skin coat using direct lamination (described above). The structural layers were infused using the technique described above. The surface structure spectrum of the panels was analyzed one week after the infusion. The results are summarized in Table 5 and FIG. 3.

TABLE 4
The effect of thickness on print-through for Example 2 (Wd).

| Cosmetic Layer | | | Print-through Control Layer | | |
|---|---|---|---|---|---|
| Thickness (mm) | | | 3M ™ VHB ™ Adhesive | | |
| | Skin | | Transfer Tape 9460 | Thickness | |
| Gel coat | coat | Total | Designation | (mm) | W_{d} |
| 0.5 | 0 | 0.5 | No PTL Control | 0 | 68.2 |
| 0.5 | 0 | 0.5 | 9460-10 | 0.25 | 56.9 |
| 0.5 | 0 | 0.5 | 9460-20 | 0.41 | 21.6 |
| 0.5 | 0 | 0.5 | 9460-40 | 1.02 | 8.6 |

TABLE 5
The effect of thickness on print-through for Example 3 (Wd).

| Cosmetic Layer | | | | | |
|---|---|---|---|---|---|
| Thickness (mm) | | | Print-through Control Layer | | |
| | Skin | | 3M ™ VHB ™ Tape | Thickness | |
| Gel coat | coat | Total | Designation | (mm) | W_{d} |
| 0.5 | 0 | 0.5 | No PTL Control | 0 | 68.2 |
| 0.5 | 0 | 0.5 | 4926 | 0.38 | 23.6 |
| 0.5 | 0 | 0.5 | 4936 | 0.64 | 15.0 |
| 0.5 | 0 | 0.5 | 4941 | 1.14 | 7.6 |
| 0.5 | 0 | 0.5 | 4956 | 1.57 | 6.6 |

### Example 4

Increasing 4950 VHB Series Thickness with No Skin Coat. Referring to FIG. 4, various 3M™ VHB™ Tapes in the 4950 family of tapes, as listed below were directly laminated to the gel coat with no applied skin coat using direct lamination (described above). The structural layers were infused using the technique described above. The surface structure spectrum of the panels was analyzed one week after the infusion. The results are summarized in Table 6 and FIG. 4.

TABLE 6
The effect of thickness on print-through control for Example 4 (Wd).

| Cosmetic Layer | | | | | |
|---|---|---|---|---|---|
| Thickness (mm) | | | Print-through Control Layer | | |
| | Skin | | 3M ™ VHB ™ Tape | Thickness | |
| Gel coat | coat | Total | Designation | (mm) | W_{d} |
| 0.5 | 0 | 0.5 | No PTL Control | 0 | 68.2 |
| 0.5 | 0 | 0.5 | 4920 | 0.38 | 62.8 |
| 0.5 | 0 | 0.5 | 4930 | 0.64 | 20.5 |
| 0.5 | 0 | 0.5 | 4950 | 1.14 | 13.4 |
| 0.5 | 0 | 0.5 | 4955 | 2.03 | 11.4 |

### Example 5

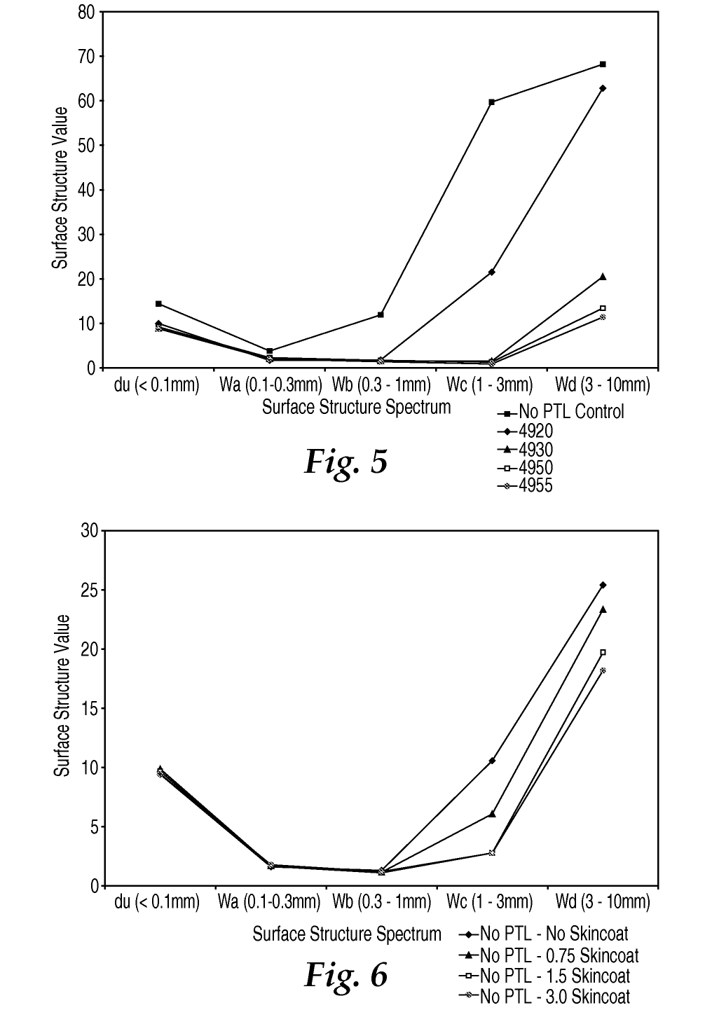

No Print-through Layer with Increasing Skin Coat. Referring now to FIG. 5, skin coats with the thicknesses listed below were fabricated on gel coats as described above. No print-through layers were attached. The structural layers were infused using the technique described above. The surface structure spectrum of the panels was analyzed one week after the infusion. The results are summarized in Table 7 and FIG. 5.

TABLE 7
The effect of increasing skin coat thickness on print-through control for
Example 5 (Wd).

| Cosmetic Layer | | | | |
|---|---|---|---|---|
| Thickness (mm) | | | | |
| | Skin | | | |
| Gel coat | coat | Total | Designation | W_{d} |
| 0.5 | 0 | 0.5 | No PTL - No Skin coat | 25.4 |
| 0.5 | 0.9 | 1.4 | No PTL - 0.75 Skin coat | 23.3 |
| 0.5 | 1.8 | 2.3 | No PTL - 1.5 Skin coat | 19.7 |
| 0.5 | 3.6 | 4.1 | No PTL - 3.0 Skin coat | 18.2 |

### Example 6

Constant 4926 Thickness with Increasing Skin Coat Thickness. Referring now to FIG. 6, these examples were assembled using the one-sided CSM lamination described above. Chopped strand mat (0.75 oz/ft2) was laminated to one side of 3M™ VHB™ Tape 4926. After impregnation with resin by hand, the chopped strand mat attached to the print-through control layer supplied approximately 0.89 mm of the total skin coat thickness. Before lamination of the print-through control layer, skin coat was fabricated on the gel coat layer to result (when combined with the 0.89 mm of skin coat resulting from lamination of the chopped strand mat from the print-through control layer) in the total skin coat thicknesses listed below. After cure of the skin coat, the structural layers were infused using the technique described above. The surface structure spectrum of the panels was analyzed one week after the infusion. The results are summarized in Table 8 and FIG. 6.

TABLE 8
The effect of skin coat thickness on print-through control for
Example 6 (Wd).

| Cosmetic Layer | | | | | |
|---|---|---|---|---|---|
| Thickness (mm) | | | Print-through Control Layer | | |
| | Skin | | 3M ™ VHB ™ Tape | Thickness | |
| Gel coat | coat | Total | Designation | (mm) | W_{d} |
| 0.5 | 0 | 0.5 | 4926 - No Skin coat | 0.38 | 17.2 |
| 0.5 | 0.9 | 1.4 | 4926 - 0.75 Skin coat | 0.38 | 3.0 |
| 0.5 | 1.8 | 2.3 | 4926 - 1.5 Skin coat | 0.38 | 3.8 |
| 0.5 | 3.6 | 4.1 | 4926 - 3.0 Skin coat | 0.38 | 4.0 |

### Example 7

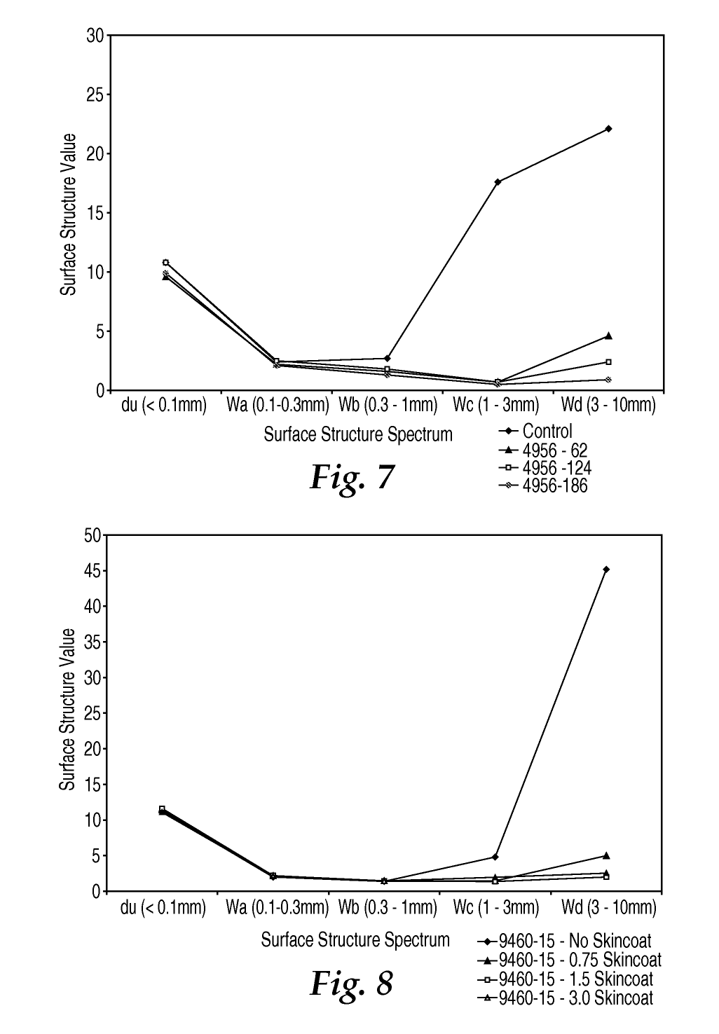

Constant 9460 Thickness with Increasing Skin coat Thickness. Referring to FIG. 7, these examples were assembled using the one-sided CSM lamination described above. 3M™ VHB™ Adhesive Transfer Tape 9460 was hand-laminated to 0.38 mm for use as print-through control layer. Chopped strand mat (0.75 oz/ft2) was laminated to one side of the print-through control layer. After impregnation with resin by hand, the chopped strand mat attached to the print-through control layer supplied approximately 0.89 mm of the total skin coat thickness. Before lamination of the print-through control layer, skin coat was fabricated on the gel coat layer to result (when combined with the 0.89 mm of skin coat resulting from lamination of the chopped strand mat from the print-through control layer) in the total skin coat thicknesses listed below. After cure of the skin coat, the structural layers were infused using the technique described above. The surface structure spectrum of the panels was analyzed one week after the infusion. The results are summarized in Table 9 and FIG. 7.

TABLE 9
The effect of skin coat thickness on print-through control for
Example 7 (Wd).

| Cosmetic Layer | | | Print-through Control Layer | | |
|---|---|---|---|---|---|
| Thickness (mm) | | | 3M ™ VHB ™ Adhesive | | |
| | Skin | | Transfer Tape 9460 | Thickness | |
| Gel coat | coat | Total | Designation | (mm) | W_{d} |
| 0.5 | 0 | 0.5 | 9460-15 - No Skin coat | 0.38 | 45.2 |
| 0.5 | 0.9 | 1.4 | 9460-15 - 0.75 Skin coat | 0.38 | 5.0 |
| 0.5 | 1.8 | 2.3 | 9460-15 - 1.5 Skin coat | 0.38 | 2.0 |
| 0.5 | 3.6 | 4.1 | 9460-15 - 3.0 Skin coat | 0.38 | 2.6 |

### Example 8

Increasing Skin coat with Constant 4926 with Additional CSM Layer Behind the Compressible Layer. Referring to FIG. 8, these examples were assembled using the two-sided CSM lamination described above. Chopped strand mat (0.75 oz/ft2) was laminated to both sides of 3M™ VHB™ Tape 4926. After impregnation with resin by hand, the chopped strand mat attached to the print-through control layer supplied approximately 0.89 mm of the total skin coat thickness. Before lamination of the print-through control layer, skin coat was fabricated on the gel coat layer to result (when combined with the 0.89 mm of skin coat resulting from lamination of the chopped strand mat from the print-through control layer) in the total skin coat thicknesses listed below. After installation of the print-through control layer, the additional chopped strand mat on the backside of the print-through control layer was laminated to result in an additional 0.89 mm layer of resin impregnated chopped strand mat between the print-through control layer and the structural layers. The structural layers were infused using the technique described above. The surface structure spectrum of the panels was analyzed one week after the infusion. The results are summarized in Table 10 and FIG. 8.

TABLE 10
The effect of skin coat thickness on print-through control for
Example 8 (Wd).

| Cosmetic Layer | | | Print-through Control Layer | | Additional | |
|---|---|---|---|---|---|---|
| Thickness (mm) | | | | Thick- | CSM | |
| Gel | Skin | | 3M ™ VHB ™ | ness | Layer | |
| coat | coat | Total | Tape Designation | (mm) | (mm) | W_{d} |
| 0.5 | 0.0 | 0.5 | No Skin coat - No | 0 | 0.89 | 20.3 |
| | | | PTL - 0.75 CSM | | | |
| 0.5 | 0.0 | 0.5 | No Skin Coat - 4926 - | 0.38 | 0.89 | 2.8 |
| | | | 0.75 CSM | | | |
| 0.5 | 0.9 | 1.4 | 0.75 Skin coat - 4926 - | 0.38 | 0.89 | 1.6 |
| | | | 0.75 CSM | | | |
| 0.5 | 1.8 | 2.3 | 1.5 Skin coat - 4926 - | 0.38 | 0.89 | 1.2 |
| | | | 0.75 CSM | | | |
| 0.5 | 2.7 | 3.2 | 2.3 Skin coat - 4926 - | 0.38 | 0.89 | 1.3 |
| | | | 0.75 CSM | | | |
| 0.5 | 3.6 | 4.1 | 3.0 Skin coat - 4926 - | 0.38 | 0.89 | 1.6 |
| | | | 0.75 CSM | | | |

### Example 9

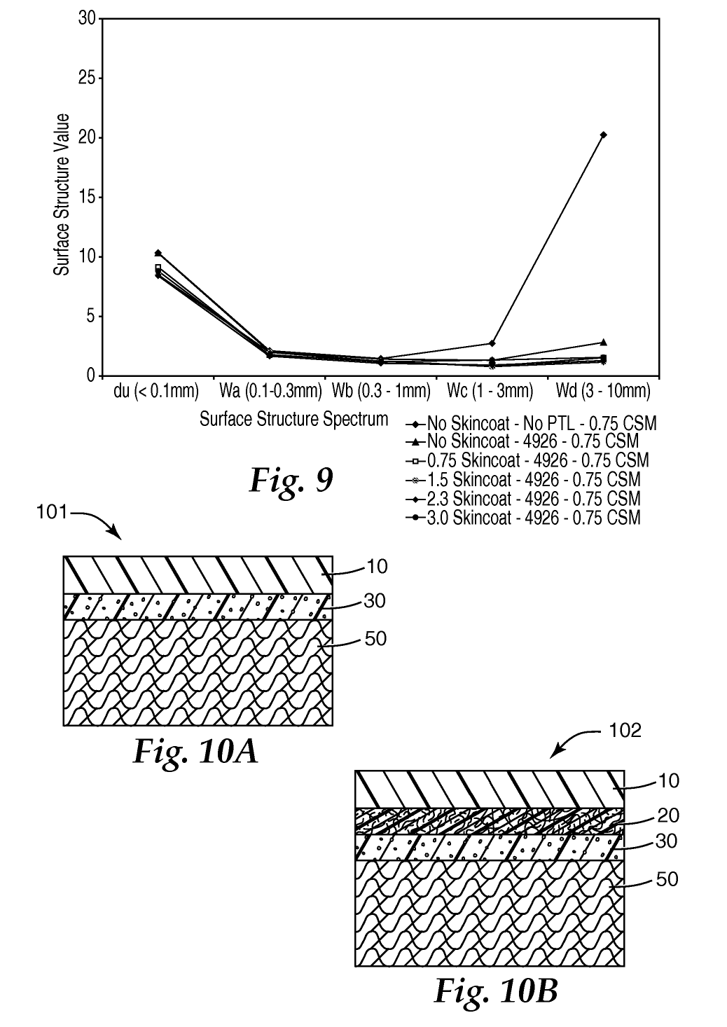

VHB 4926 Increasing Thickness with Constant Skin coat Thickness. Referring now to FIG. 9, 3M™ VHB™ Tape 4926 was hand-laminated to the thicknesses listed below for use as print-through control layer. Each print-through control material was directly laminated to the gel coat with no applied skin coat using direct lamination (described above). The structural layers were infused using the technique described above. The surface structure spectrum of the panels was analyzed four days after the infusion. The results are summarized in Table 11 and FIG. 9.

TABLE 11
The effect of skin coat thickness on print-through control for
Example 9 (Wd).

| Cosmetic Layer | | | | | |
|---|---|---|---|---|---|
| Thickness (mm) | | | Print-through Control Layer | | |
| | Skin | | 3M ™ VHB ™ Tape | Thickness | |
| Gel coat | coat | Total | Designation | (mm) | W_{d} |
| 0.5 | 0 | 0.5 | 4926 | 0 | 22.1 |
| 0.5 | 0 | 0.5 | 4926 | 1.57 | 4.6 |
| 0.5 | 0 | 0.5 | 4926 | 3.15 | 2.4 |
| 0.5 | 0 | 0.5 | 4926t | 4.72 | 0.9 |

Various modifications and alterations of this invention will become apparent to those skilled in the art without departing from the scope and spirit of this invention.

What is claimed is:

1. A composite article comprising:
a cosmetic layer having a Young's modulus of at least 1.0 GPa;
a structural layer comprising a fiber reinforced resin; and
a compressible layer positioned between said cosmetic layer and said structural layer, wherein said compressible layer has a Young's modulus of less than or equal to 50 MPa.

2. The composite article of claim 1, wherein the cosmetic layer comprises a surface layer and at least one skin coat.

3. The composite article of claim 1, further comprising a fiber reinforced layer between the compressible layer and the structural layer.

4. The composite article of claim 1, wherein the compressible layer has a Young's modulus of no greater than 10 MPa.

5. The composite article of claim 1, wherein the compressible layer has a Poisson's ratio no greater than 0.49.

6. The composite article of claim 1, wherein said compressible layer has a thickness of greater than or equal to 0.05 mm and less than or equal to 5 mm.

7. The composite article of claim 1, wherein said compressible layer has a Young's modulus of no greater than 1 MPa, a Poisson's ratio no greater than 0.42, and a thickness of greater than or equal to about 0.5 mm and less than or equal to about 3 mm

8. The composite article of claim 1, wherein said compressible layer is a solid polymer selected from the group consisting of acrylic polymer, epoxy, and mixtures thereof.

9. The composite article of claim 1, wherein said compressible layer comprises a foam.

10. The composite article of claim 1, wherein said compressible layer comprises holes extending through the thickness of the compressible layer.

11. A method of controlling print-through comprising:
positioning a compressible layer having a Young's modulus of less than or equal to 50 MPa between a cosmetic layer having a Young's modulus of at least 1 GPa;
and a structural layer comprising a fiber reinforced resin; and
curing the resin to form a composite article.

12. The method according to claim 11, further comprising positioning a fiber reinforced layer between the compressible layer and the structural layer.

13. The method according to claim 11, wherein the compressible layer has a Young's modulus of no greater than 10 MPa, a Poisson's ratio no greater than 0.49, and a thickness greater than or equal to 0.05 mm and less than or equal to 5 mm.

14. The method according to claim 13, wherein the compressible layer has a Young's modulus of no greater than 1 MPa, a Poisson's ratio no greater than 0.40, and a thickness greater than or equal to 0.5 mm and less than or equal to 3 mm.

15. A method of forming a composite article comprising
positioning a compressible layer having a Young's modulus of less than or equal to 50 MPa between a cosmetic layer having a Young's modulus of at least 1 GPa;
and a structural layer comprising fiber reinforcements and a structural resin; and
curing the resin to form a composite article.

16. The method of claim 15, further comprising infusing the fibrous reinforcements with the structural resin, optionally wherein infusing comprises vacuum infusing.

17. A print-through control layer comprising a compressible layer and at least one skin coat.

18. The print-through control layer of claim 17 wherein the compressible layer has a Young's modulus of no greater than 10 MPa and a Poisson's ratio no greater than 0.49.

19. The print-through control layer of claim 18, wherein said compressible layer is a solid polymer selected from the group consisting of acrylic polymer, epoxy, and mixtures thereof.

20. The print-through control layer of claim 18, wherein said compressible layer comprises holes extending through the thickness of the compressible layer.
